(19) United States
(12) Patent Application Publication
(10) Pub. No.: US 2007/0057855 A1
(43) Pub. Date: Mar. 15, 2007

(54) Portable information apparatus incorporating wireless communication antenna

(75) Inventors: Satoshi Mizoguchi, Oume-shi (JP); Takashi Amano, Souka-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/516,529

(22) Filed: Sep. 7, 2006

(30) Foreign Application Priority Data
Sep. 7, 2005 (JP) 2005-259961

(51) Int. Cl. H01Q 1/24

(52) U.S. Cl. 343/702

(57) ABSTRACT

According to one embodiment, there is provided a portable information apparatus including: a main body; a display unit attached to the main body; a first wireless communication antenna attached to an upper portion of the display unit; and a second wireless communication antenna attached to one of side portions of the display unit.

### CROSS-REFERENCE TO RELATED APPLICATIONS

This application is based upon and claims the benefit of priority from Japanese Patent Application No. 2005-259961, filed Sep. 7, 2006, the entire contents of which are incorporated herein by reference.

### BACKGROUND

1. Field

One embodiment of the invention relates to a portable information apparatus incorporating a wireless communication antenna whose communication performance is enhanced by a diversity effect.

2. Description of the Related Art

Recently, in association with development of a communication technique, wireless communication using radio waves has become rapidly widespread in place of a wired communication using a feeding cable. In order to enhance the quality of wireless communication, various pieces of communication equipment employ techniques such as diversity techniques for enhancing radio receiving performance by use of a plurality of antennas.

Among the diversity techniques, principal techniques include a space diversity technique for placing a plurality of antennas at a plurality of spatially-separated positions in order to set different receiving conditions by adjusting the propagation distance of radio waves; a polarization diversity technique for selecting and utilizing, as appropriate, an antenna having superior sensitivity from among a plurality of antennas having different planes of polarization in order to lessen a fading phenomenon attributable to a misalignment in the plane of polarization of radio waves; and a pattern diversity technique of selecting and utilizing, as appropriate, an antenna having superior sensitivity by use of a plurality of antennas having different radiation patterns.

Incidentally, the wireless communication technique is widely used in a PC (personal computer) network. A notebook-type personal computer incorporating a built-in wireless communication antenna (hereinafter called “notebook PC”) has also been developed. In the notebook PCs incorporating the built-in wireless communication antennas, a notebook PC adopting a diversity technique while incorporating a plurality of antennas is disclosed by, for example, Japanese Patent Application Publication (KOKAI) No. 2002-73210.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A is an exemplary perspective view showing a layout and configuration of wireless LAN antennas in a notebook PC according to a first embodiment of the present invention;

FIG. 1B is an exemplary perspective view showing the layout and configuration of wireless LAN antennas in the notebook PC according to the first embodiment of the present invention;

FIGS. 2A and 2B are exemplary perspective views showing the configuration of the wireless LAN antennas according to the first embodiment of the present invention;

FIG. 3 is an exemplary perspective view showing positions on the notebook PC where the wireless LAN antennas of the first embodiment of the present invention are attached;

FIG. 4 is an exemplary block diagram showing a hardware configuration of the notebook PC according to the first embodiment of the present invention;

FIG. 5 is an exemplary block diagram showing a configuration of a wireless LAN module according to the first embodiment of the present invention;

FIGS. 6A and 6B are exemplary perspective views showing a layout and configuration of wireless LAN antennas in a notebook PC according to a second embodiment of the present invention;

FIG. 7 is an exemplary perspective view showing a layout and configuration of wireless LAN antennas in a notebook PC according to a third embodiment of the present invention;

FIGS. 8A and 8B are exemplary perspective views showing that a display unit of the notebook PC according to the third embodiment of the present invention is closed to a main body;

FIGS. 9A and 9B are exemplary perspective views showing that a display unit of a notebook PC according to a fourth embodiment of the present invention is closed to a main body;

FIGS. 10A and 10B are exemplary perspective views showing that a display unit of a notebook PC according to a fifth embodiment of the present invention is closed to a main body;

FIG. 11 is an exemplary perspective view showing a layout and configuration of wireless LAN antennas in a notebook PC according to a sixth embodiment of the present invention; and

FIG. 12 is an exemplary perspective view showing a layout and configuration of wireless LAN antennas in a notebook PC according to a seventh embodiment of the present invention.

### DETAILED DESCRIPTION

Various embodiments according to the invention will be described hereinafter with reference to the accompanying drawings. In general, according to one embodiment of the invention, there is provided a portable information apparatus comprising: a main body; a display unit attached to the main body; a first wireless communication antenna attached to an upper portion of the display unit; and a second wireless communication antenna attached to one of side portions of the display unit.

### First Embodiment

A first embodiment describes a notebook PC that serves as a portable information apparatus is equipped with wireless LAN antennas employed as first and second wireless communication antennas.

(Layout and Configuration of Antennas)

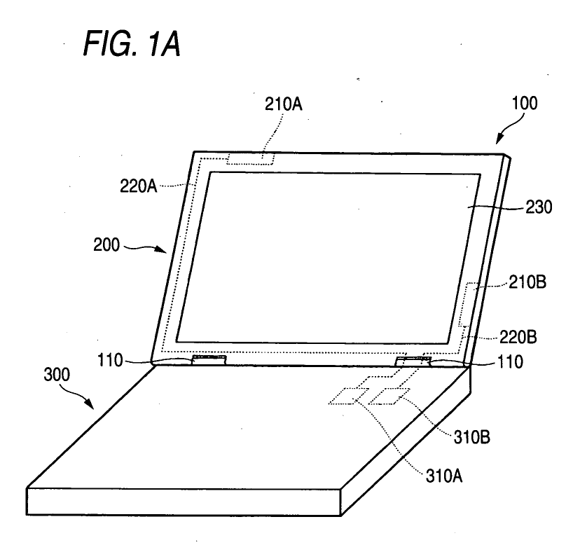

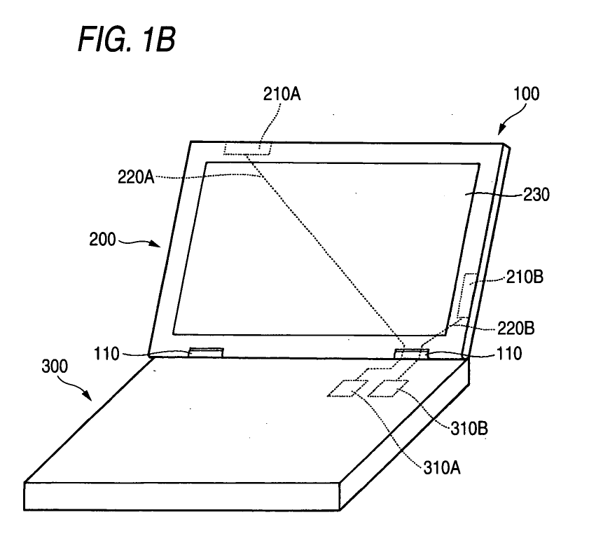

FIG. 1A is an exemplary perspective view showing a layout and configuration of the wireless LAN antennas in the notebook PC of the first embodiment of the present invention.

As illustrated, the notebook PC includes a display unit 200 and a main body 300. In the first embodiment, the display unit 200 is a liquid-crystal display having a liquid-crystal panel 230.

An antenna 210A for use with a wireless LAN (hereinafter called a “wireless LAN antenna”) is attached to left side of an upper portion of the display unit 200, and a wireless LAN antenna 210B is attached to lower side of a side portion of the display unit 200. By such the layout, the distance between the location where the wireless LAN antenna 210A is attached and the location where the wireless LAN antenna 210B is attached becomes greater than in a case where both antennas are attached side by side at the upper portion. Further, the wireless LAN antenna 210B is attached with an inclination of 90° with respect to the wireless LAN antenna 210A.

Wireless LAN modules 310A, 310B, which serve as wireless communication modules, are provided in the main body 300.

A feeding cable 220A extends from the wireless LAN antenna 210A so as to pass by the neighborhood of a left side surface of the display unit 200 and so as to be connected to the module 310A for use with a wireless LAN (hereinafter called a “wireless LAN module”) by way of a hinge 110. Meanwhile, a feeding cable 220B extends downwardly from the wireless LAN antenna 210B; passes through the hinge 110; and is connected to the wireless LAN module 310B. The reason for this is that the feeding cable connected to one antenna does not run near the other antenna. A thin line coaxial cable of the order of 1 mm can be used as the feeding cable 220A and 220B.

When the display unit 200 has a sufficient thickness and the feeding cables 220A, 220B can be caused to pass to the back of the liquid-crystal panel 230, the feeding cables 220A, 220B can be wired, as shown in FIG. 1B, such that the wireless LAN antennas 210A, 210B and the hinge 110 are connected over the shortest distance.

The wireless LAN antenna 210A may be attached to right side of the upper portion of the display unit 200, and the wireless LAN antenna 210B may be attached to lower side of the left side portion of the display unit 200. The reason for this is that the wireless LAN antenna 210A and the wireless LAN antenna 210B are intended to be placed 90° apart while being separated as far as possible from each other. In other words, the wireless LAN antenna 210A and the wireless LAN antenna 210B are separated as far as a diagonal distance of the display unit 200.

In such a case, the feeding cable 220A extends from the wireless LAN antenna 210A so as to pass by the neighborhood of the right side face of the display unit 200 and so as to be connected to the wireless LAN module 310A by way of the hinge 110. The feeding cable 220B extends downwardly from the wireless LAN antenna 210B and is connected to the wireless LAN module 310B by way of the hinge 110.

(Configuration of the Antenna)

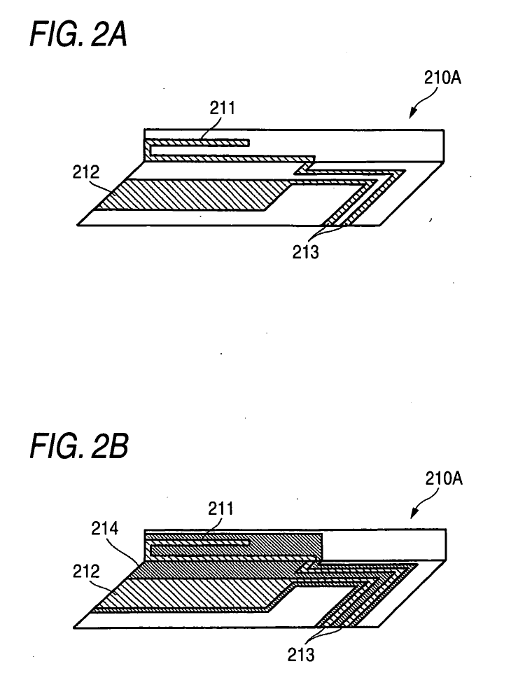

FIGS. 2A and 2B are exemplary perspective views showing the configuration of the wireless LAN antenna according to the first embodiment of the present invention. Since the wireless LAN antennas 210A, 210B have the same configuration, the wireless LAN antenna 210A is described as a typical antenna.

FIG. 2A shows the wireless LAN antenna 210A, where an antenna conductor section 211, a GND pattern 212, and a feeding line 213, all being formed from a conductive material such as metal, are provided directly on the enclosure of the notebook PC 100, when an enclosure of the notebook PC 100 shown in FIG. 1A is formed from a dielectric material such as resin or the like. The enclosure of the notebook PC 100 is utilized as a dielectric portion of the wireless LAN antenna 210A.

The wireless LAN antenna 210A is formed from a plane of small area including the antenna conductor section 211 and a plane of large area including the GND pattern 212. These planes are in a positional relationship where the large plane and the small plane intersect at right angles. The feeding line 213 is connected to the feeding cable 220A.

FIG. 2B shows the wireless LAN antenna 210A in which the antenna conductor section 211, the GND pattern 212, and the feeding line 213 that are formed from a conductive material such as metal are provided on a dielectric plate 214 disposed on the notebook PC 100 when the enclosure of the notebook PC 100 shown in FIG. 1A is formed from a conductive material such as metal. The entire wireless LAN antenna 210A is same in function and shape with the wireless LAN antenna 210A shown in FIG. 2A.

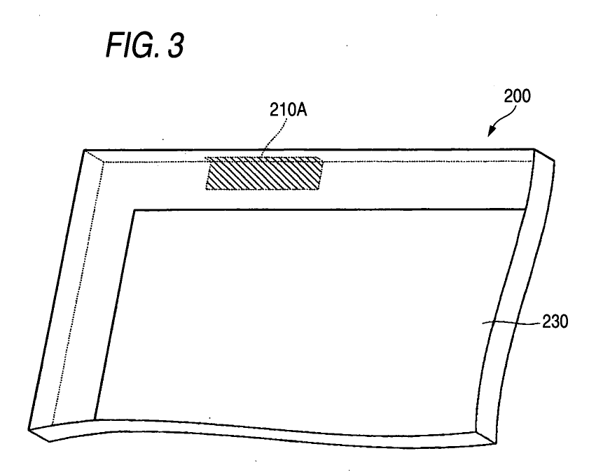

FIG. 3 is an exemplary perspective view showing the position on the notebook PC where the wireless LAN antennas of the first embodiment of the present invention are placed.

As illustrated, the wireless LAN antenna 210A is attached to the upper portion on the display unit 200 such that a larger-area surface of the wireless LAN antenna 210A including the GND pattern 212 is located on the back side of the liquid-crystal panel 230 (back side of the display unit). A smaller-area surface of the wireless LAN antenna 210A, including the antenna conductor section 211, is located on a side surface of the display unit 200. Similarly, the wireless LAN antenna 210B is attached to the lower side of the right side portion of the display unit 200.

(Hardware Configuration of the Notebook PC)

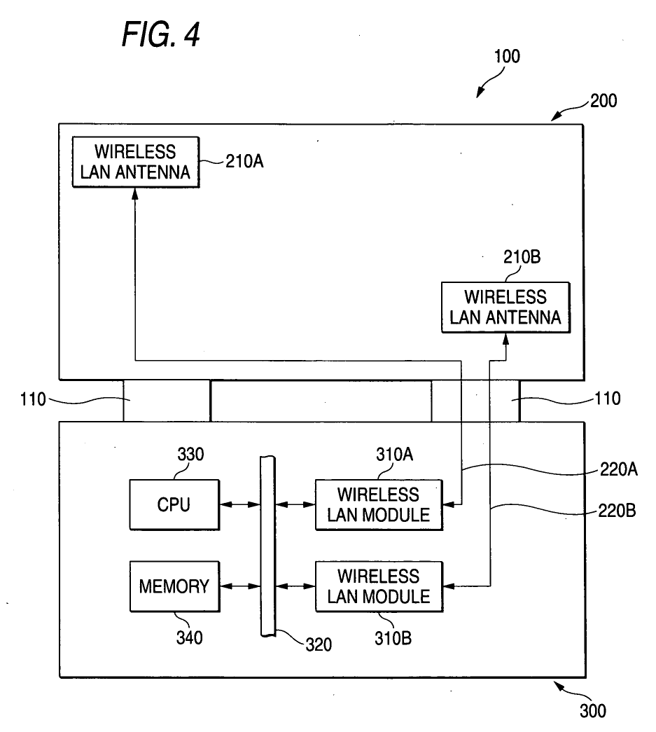

FIG. 4 is an exemplary block diagram showing the hardware configuration of the notebook PC according to the first embodiment of the present invention. The drawing shows only characteristic areas of the hardware of the present embodiment and does not show a keyboard controller, a display controller, and the like, which perform the original functions of the notebook PC.

As shown in FIG. 4, the wireless LAN antennas 210A, 210B attached to the back side of the liquid-crystal panel 230 of the display unit 200 are connected to the modules 310A, 310B for a wireless LAN (hereinafter called “wireless LAN modules”) by the feeding cables 220A, 220B. The antenna conductor section 211 of the wireless LAN antenna 210A and the antenna conductor section 211 of the wireless LAN antenna 210B are placed at orientations which differ from each other by 90°.

The wireless LAN modules 310A, 310B are connected to a CPU bus 320, and the CPU bus 320 is connected to a CPU 330 that controls the entirety of the notebook PC 100, as well as to memory 340 that stores data signals transmitted from or received from the wireless LAN antennas 210A, 210B.

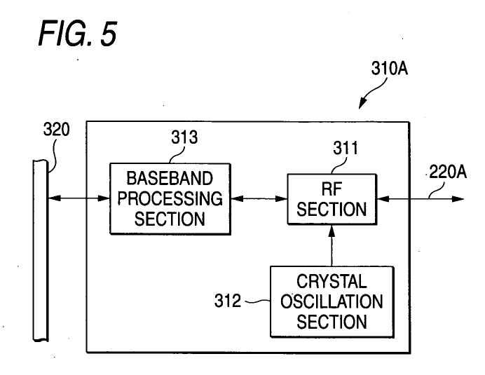

FIG. 5 is a block diagram showing the configuration of a wireless LAN module according to the first embodiment of the present invention. Since the wireless LAN modules 310A, 310B have the same configuration, the wireless LAN module 310A is described as a representative.

As illustrated, the wireless LAN module 310A includes an RF (Radio Frequency) section 311, a crystal oscillation section 312, and a baseband processing section 313.

The RF section 311 converts a high-frequency signal, which has been input from the wireless LAN antenna 210A by way of the feeding cable 220A, into a low-frequency signal, and outputs the thus-converted signal to the baseband processing section 313. The baseband signal output from the baseband processing section 313 is converted into a high-frequency signal on the basis of an oscillation frequency output from the crystal oscillation section 312, and the high-frequency signal is output to the wireless LAN antenna 210A by way of the feeding cable 220A.

The baseband processing section 313 subjects the baseband signal output from the RF section 311 to analog-to-digital conversion, to thus convert the analog signal into a digital signal which can be processed by the CPU 330 of the notebook PC and to output the resultant digital signal to the CPU bus 320. The digital signal input from the CPU bus 320 is subjected to digital-to-analog conversion, to thus convert the digital signal into an analog baseband signal and output the resultant analog signal to the RF section 311.

Operation of the notebook PC according to the first embodiment of the present invention will be described hereinbelow.

(Operation for Receiving Radio Waves)

Upon receipt of the data signal, the wireless LAN antennas 210A, 210B input the received signal, which corresponds to signal intensity, to the wireless LAN modules 310A, 310B by way of the feeding cables 220A, 220B.

The RF section 311 converts the signal, which has been received by way of the feeding cables 220A, 220B, into a low-frequency signal on the basis of the oscillation frequency of the crystal oscillation section 312, and outputs the resultant low-frequency signal to the baseband processing section 313.

The baseband processing section 313 converts the analog baseband received signal output from the RF section 311 into a digital signal which can be processed by the CPU 330 of the notebook PC 100, and outputs the resultant digital signal to the CPU bus 320. The received signal output to the CPU bus 320 is stored in the memory 340.

(Operation for Transmitting Radio Waves)

After having stored the transmission signal into the memory 340, the CPU 330 transmits the transmission signal stored in the memory 340 to the wireless LAN modules 310A, 310B by way of the CPU bus 320.

The baseband processing section 313 converts the digital transmission signal into an analog baseband signal, and outputs the resultant analog baseband signal to the RF section 311. The RF section 311 converts the transmission signal into the high-frequency signal used for wireless LAN communication on the basis of the oscillation frequency of the crystal oscillation section 312, and outputs the resultant high-frequency signal to the wireless LAN antennas 210A, 210B by way of the feeding cables 220A, 220B. The transmission signal is thus transmitted from the wireless LAN antennas 210A, 210B.

(Advantage of the First Embodiment)

According to the first embodiment, the space diversity effect is achieved by increasing the distance between the position where the wireless LAN antenna 210A is attached and the position where the wireless LAN antenna 210B is attached, to thus enhance efficiency in radio wave reception.

According to the first embodiment, the wireless LAN antenna 210A and the wireless LAN antenna 210B are disposed at orientations which differ from each other by 90°, and receive different polarized waves, to thus achieve a polarization diversity effect and enhance efficiency in radio wave reception.

According to the first embodiment, the wireless LAN antenna 210A and the wireless LAN antenna 210B are disposed at orientations which differ from each other by 90°, and form different radiation patterns, to thus achieve a pattern diversity effect and enhance efficiency in radio wave reception.

According to the first embodiment, occurrence of variations in the characteristics of the antenna, such as an operating frequency and a radiation pattern is prevented, due to the feeding cable connected to one of the wireless LAN antennas 210A, 210B passing in close proximity to the other antenna.

According to the first embodiment, the wireless LAN antennas 210A, 210B are integrally provided in conjunction with the enclosure of the notebook PC 100, thereby strictly maintaining constant the distance between the wireless LAN antennas 210A, 210B and the enclosure of the notebook PC 100. Thus, occurrence of variations in the characteristics of the antenna, such as an operating frequency and a radiation pattern, is prevented, and high reception efficiency can be obtained.

### Second Embodiment

In a second embodiment of the present invention, the position where a wireless LAN antenna is attached is determined on the basis of the layout of a liquid-crystal drive circuit substrate equipped with an IC that controls driving of liquid crystal of a liquid-crystal panel. The configuration and operation of the notebook PC are analogous to those of the notebook PC of the first embodiment, and hence their repeated explanations are omitted.

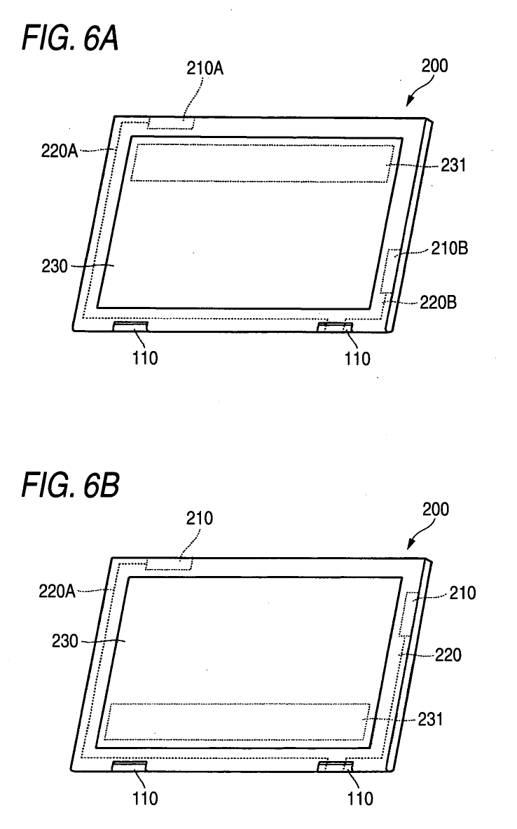

FIGS. 6A and 6B are exemplary perspective views showing the layout and configuration of the wireless LAN antennas in the notebook PC of the second embodiment.

FIG. 6A shows a case where the liquid-crystal drive circuit substrate 231 is provided in an upper portion of the liquid-crystal panel 230. At this time, the wireless LAN antenna 210B is positioned at the lower side of the right side portion of the display unit 200. The reason for this is to place the antenna as far as possible from the liquid-crystal drive circuit substrate 231, which is a major EMI (Electromagnetic Interference) noise source in the liquid-crystal panel 230.

FIG. 6B shows a case where the liquid-crystal drive circuit substrate 231 is located in the lower portion of the liquid-crystal panel 230. At this time, for the same reason, the wireless LAN antenna 210B is positioned at upper side of the right side portion of the display unit 200.

(Advantage of the Second Embodiment)

According to the second embodiment, the wireless LAN antenna 210B is attached while being spaced apart from the liquid-crystal drive circuit substrate 231, thereby diminishing the influence of unwanted emission from the liquid-crystal drive circuit substrate 231 to thus lessen noise, so that efficiency in radio wave reception can be enhanced.

### Third Embodiment

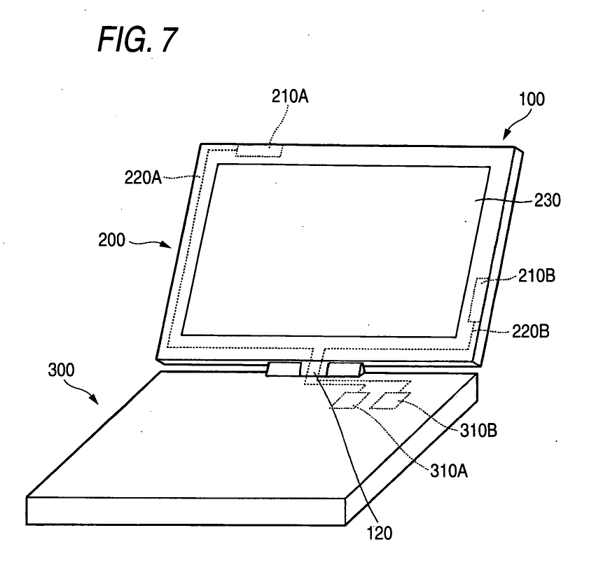

FIG. 7 is an exemplary perspective view showing the layout and configuration of wireless LAN antennas in a notebook PC according to a third embodiment of the present invention.

As illustrated, the notebook PC 100 of the present embodiment has a configuration where a main body 300 and the display unit 200 are connected together by means of a rotational hinge 120. By means of such a configuration, the display unit 200 can freely rotate around the rotational hinge 120, to thus enable the display unit 200 to be closed to the main body 300 with the liquid-crystal panel oriented outward.

Here, the wireless LAN antenna 210A is attached to a front side (the side facing the liquid-crystal panel 230) of the display unit 200, and the wireless LAN antenna 210B is attached to the back side of the display unit 200. Descriptions of other configuration features of the antenna analogous to that of its counterpart in the first embodiment are omitted.

The wireless LAN antenna 210A may be attached to the front side of the display unit 200, and the wireless LAN antenna 210B may be attached to the front side of the display unit 200.

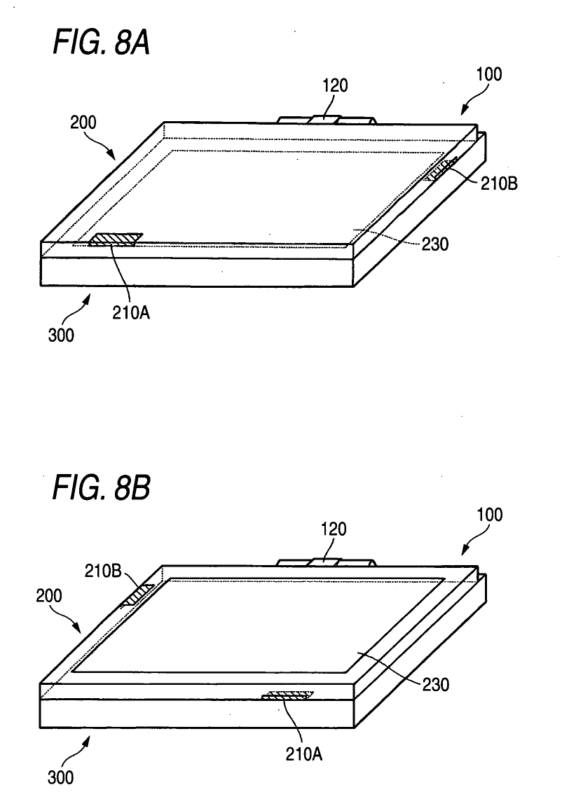

FIG. 8A is an exemplary perspective view of a notebook PC 100 acquired when the display unit 200 is closed to the main body 300 with the liquid-crystal panel oriented toward the inside. Display of the feeding cables 220A, 220B, and the like, is omitted.

At this time, when the enclosure of the main body 300 is made from metal, the wireless LAN antenna 210B is positioned close to the enclosure of the main body 300, and hence the performance of the wireless LAN antenna 210B is deteriorated. However, the wireless LAN antenna 210A is not located in close proximity to the metal enclosure of the main body 300, and hence the performance of the wireless LAN antenna 210A is not deteriorated.

FIG. 8B is a perspective view of the notebook PC 100 acquired when the display unit 200 is closed to the main body 300 with the liquid-crystal panel oriented toward the outside. Display of the feeding cables 220A, 220B, and the like is omitted.

At this time, the wireless LAN antenna 210A is located in close proximity to the enclosure of the main body 300, and hence the performance of the wireless LAN antenna 210A is deteriorated. However, the wireless LAN antenna 210B is not located in close proximity to the metal enclosure of the main body 300, and hence the performance of the wireless LAN antenna 210B is not deteriorated.

(Advantage of the Third Embodiment)

According to the third embodiment, one of the wireless LAN antennas 210A, 210B is attached to the front side of the display unit 200, and the other is attached to the back side of the display unit 200. Even when either the front side or back side of the display unit 200 is oriented outward when the display unit 200 is closed to the main body 300, neither of the wireless LAN antennas 210A, 210B comes into close proximity to the metal enclosure of the main body 300, and hence deterioration of performance of the wireless LAN antenna can be prevented. High-quality wireless communication can be performed even when the display unit 200 is closed.

### Fourth Embodiment

As in the case of the third embodiment, the notebook PC 100 according to a fourth embodiment of the present invention has a configuration where the main body 300 and the display unit 200 are connected together by the rotational hinge 120. By such a configuration, the display unit 200 can freely rotate around the rotational hinge 120, and the display unit 200 can be closed to the main body 300 with the liquid-crystal panel oriented outward.

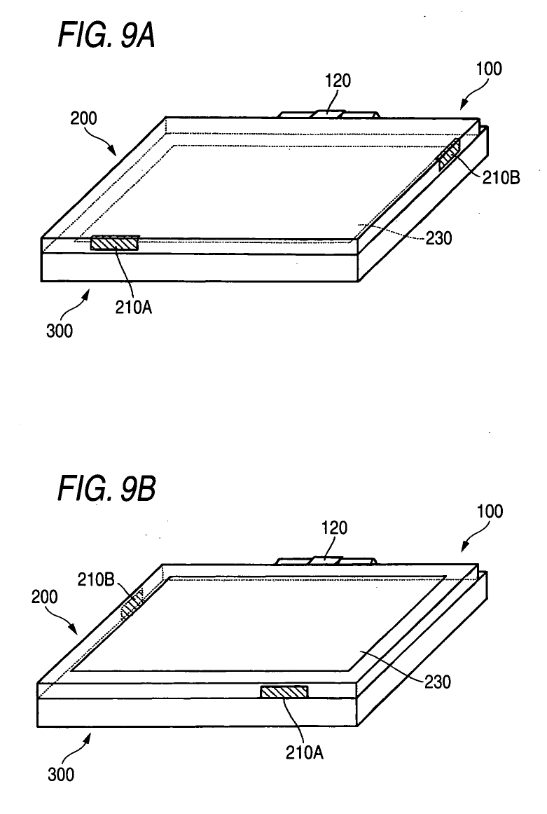

FIG. 9A shows an exemplary perspective view of the notebook PC 100 acquired when the display unit 200 is closed to the main body 300 with the liquid-crystal panel oriented inwardly, and FIG. 9B is a perspective view of the notebook PC 100 acquired when the display unit 200 is closed to the main body 300 with the liquid-crystal panel being oriented outwardly. Display of the feeding cables 220A, 220B, and the like, is omitted.

As illustrated, the wireless LAN antennas 210A, 210B are attached to the side surfaces of the display unit 200.

In the drawing, the wireless LAN antennas 210A, 210B are provided such that the smaller-area surface including the antenna conductor sections 211 of the wireless LAN antennas 210A, 210B comes to the back side of the display unit 200. However, one or both of the wireless LAN antennas 210A, 210B may be provided such that the smaller-area surface including the antenna conductor sections 211 comes to the front side of the display unit 200.

(Advantage of a Fourth Embodiment)

According to the fourth embodiment, the wireless LAN antennas 210A, 210B are attached to the side surfaces of the display unit 200. As a result, even when either the front or back of the display unit 200 is oriented outwardly at the time of the display unit 200 being closed to the main body 300, neither the wireless LAN antenna 210A nor the wireless LAN antenna 210B comes into close proximity to the metal enclosure of the main body 300. Hence, deterioration in performance of the antenna can be prevented, and high-quality wireless communication can be performed with the display unit 200 being closed.

### Fifth Embodiment

As in the case of the third embodiment, the notebook PC 100 according to a fifth embodiment of the present invention has a configuration where the main body 300 and the display unit 200 are connected together by the rotational hinge 120. By such a configuration, the display unit 200 can freely rotate around the rotational hinge 120. The display unit 200 can be closed to the main body 300 with the liquid-crystal panel being oriented outwardly.

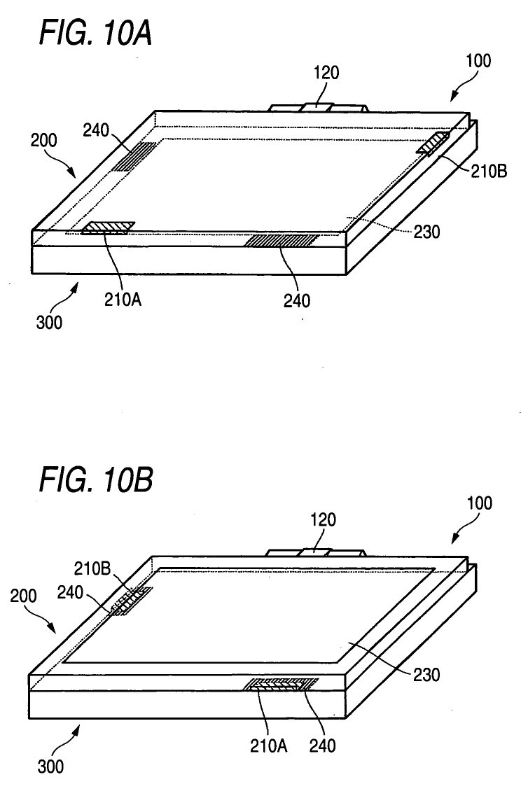

FIG. 10A shows a perspective view of the notebook PC acquired when the display unit 200 is closed to the main body 300 with the liquid-crystal panel being oriented inwardly, and FIG. 10B shows a perspective view of the notebook PC acquired when the display unit 200 is closed to the main body 300 with the liquid-crystal panel being oriented outwardly. Display of the feeding cables 220A, 220B, and the like is omitted.

As illustrated, when the enclosure of the main body 300 is made from metal, an insulation section 240 made of insulating material is provided on the surface of each of the areas to which the wireless LAN antennas 210A, 210B come into close proximity when the display unit 200 is closed to the main body 300.

(Advantage of the Fifth Embodiment)

According to the fifth embodiment, the insulation section 240 made of an insulating material is provided on the surface of each of the areas of the enclosure of the main body 300 to which the wireless LAN antennas 210A, 210B come into close proximity. As a result, even when either the front side or back side of the display unit 200 is oriented outwardly when the display unit 200 is closed to the main body 300, neither the wireless LAN antenna 210A nor 210B comes in close proximity to the metal enclosure of the main body 300, so that deterioration in performance of the antenna can be prevented. High-quality radio communication can be performed even when the display unit 200 is closed.

### Sixth Embodiment

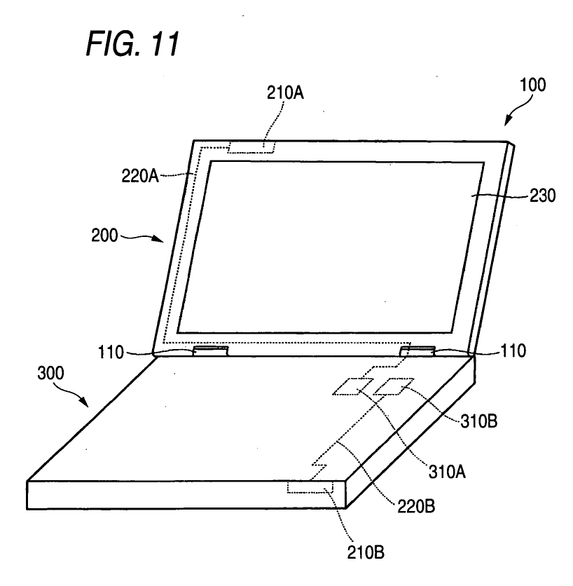

FIG. 11 is an exemplary perspective view showing the layout and configuration of the wireless LAN antennas in a notebook PC according to a sixth embodiment of the present invention.

As illustrated, the notebook PC 100 has a configuration where the wireless LAN antenna 210B is provided on the main body 300. The wireless LAN antenna 210B is connected to the wireless LAN module 310B by the feeding cable 220B. Descriptions of the other configuration features of the antenna analogous to those of its counterpart in the first embodiment are omitted.

The wireless LAN antenna 210B is attached to right side of a proximal portion of the main body 300. The proximal portion is a portion of the main body 300 at far side from the position to which the display unit is attached. The reason for this is to make the distance of the wireless LAN antenna. 210B from the wireless LAN antenna 210A as far as possible.

The wireless LAN antenna 210B may also be provided at right side of a distal portion of the main body 300. The distal portion is a portion of the main body 300 at near side from the position to which the display unit is attached. The reason for this is to make the distance of the wireless LAN antenna 210B from the wireless LAN antenna 210A as far as possible when the display unit 200 is closed to the main body 300.

In order to acquire a polarization diversity effect, the wireless LAN antenna 210B may be provided on the side of the main body.

(Advantage of the Sixth Embodiment)

According to the sixth embodiment, the distance between the wireless LAN antenna 210A and the wireless LAN antenna 210B becomes greater as compared with a case where both antennas are attached to the display unit 200. Hence, the space diversity effect can be acquired more efficiently.

### Seventh Embodiment

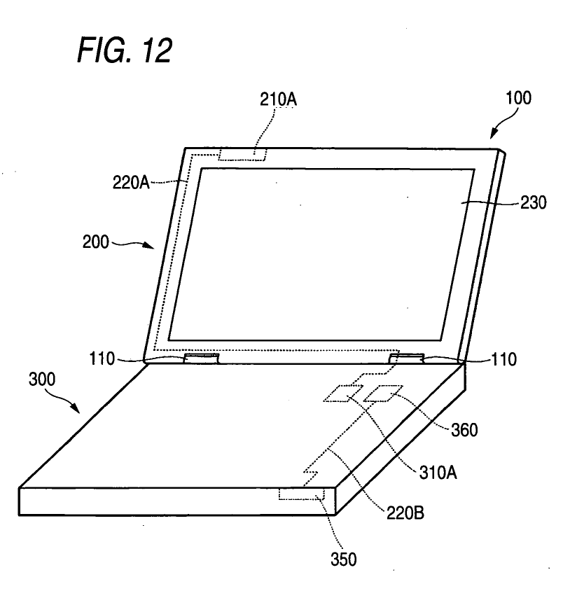

FIG. 12 is an exemplary perspective view showing the layout and configuration of the wireless LAN antennas of a notebook PC according to a seventh embodiment of the present invention.

As illustrated, the notebook PC 100 has a configuration where a Bluetooth antenna 350 is attached to the main body 300. The Bluetooth antenna 350 is connected to a Bluetooth module 360 by the feeding cable 220B. Descriptions of the other configurational features of the antenna analogous to those of its counterpart in the first embodiment are omitted.

(Advantage of the Seventh Embodiment)

According to the seventh embodiment, when the wireless communication antennas have to be mounted on the main body 300 and communication quality is markedly deteriorated by EMI noise developing from a CPU, or the like, in the main body 300, the deterioration in communication quality can be reduced by placing the Bluetooth antenna 350, which is comparatively resistant to noise, on the main body 300.

The present invention is not limited to the embodiments and is susceptible to various modifications within the scope of gist of the present invention. For instance, as described in connection with the respective embodiments, the wireless LAN antenna 210A and the wireless LAN antenna 210B are placed at orientations that differ from each other by 90°. However, the angle by which the antennas differ is not limited to 90°. Further, the number of wireless communication antennas is not limited to two. In addition to the configurations of the respective embodiments, additional wireless communication antennas may be provided.

What is claimed is:

1. A portable information apparatus comprising:
a main body;
a display unit attached to the main body;
a first wireless communication antenna attached to an upper portion of the display unit; and
a second wireless communication antenna attached to one of side portions of the display unit.

2. The portable information apparatus according to claim 1, wherein the first and second wireless communication antenna are same in type, and
wherein the first and second wireless communication antenna are separate as far as a diagonal distance of the display unit.

3. The portable information apparatus according to claim 1, wherein the first and second wireless communication antenna are same in type, and
wherein the first wireless communication antenna is directed to a first direction and the second wireless communication antenna is directed to a second direction that forms an angle of about 90 degrees with the first direction.

4. The portable information apparatus according to claim 1, wherein the display unit includes:
a liquid-crystal display; and
a circuit substrate that is provided with a circuit that drives the liquid-crystal display, the circuit substrate positioned at one of the upper portion and a lower portion of the display unit, and
wherein the second wireless communication antenna is positioned at the other of the upper and lower portions of the display unit.

5. The portable information apparatus according to claim 1, wherein one of the first and second wireless communication antennas is positioned at a front side of the display unit, and
wherein the other of the first and second wireless communication antennas is positioned at a back side of the display unit.

6. The portable information apparatus according to claim 1, further comprising:
a first feeding cable that connects the first wireless communication antenna to the main body, the first feeding cable being wired in the other of the side portions of the display unit; and
a second feeding cable that connects the second wireless communication antenna to the main body, the second feeding cable being wired in the one of the side portions of the display unit.

7. The portable information apparatus according to claim 1, wherein the first and second wireless communication antennas are positioned at a side surface of the display unit.

8. The portable information apparatus according to claim 1, wherein the display unit is capable of opening and closing to the main body, and
wherein the main body includes non-metallic members at positions on which the first and second wireless communication antennas respectively abut when the display unit is closed.

9. The portable information apparatus according to claim 1, wherein the display unit includes dielectric members at positions to which the first and second wireless communication antennas are respectively attached, and
wherein each of the first and second wireless communication antennas includes an antenna conductor section, feed line, and a GND pattern that are directly provided on the corresponding dielectric member.

10. The portable information apparatus according to claim 1, wherein the display unit includes:
metallic members at positions to which the first and second wireless communication antennas are respectively attached,
dielectric members disposed on the metallic members, respectively, and
wherein each of the first and second wireless communication antennas includes an antenna conductor section, a feed line and a GND pattern that are provided on the corresponding dielectric member.

11. A portable information apparatus comprising:
a main body;
a display unit attached to the main body;
a first wireless communication antenna attached to an upper portion of the display unit; and
a second wireless communication antenna attached to the main body.

12. The portable information apparatus according to claim 11, wherein the second wireless communication antenna is positioned at a proximal portion of the main body.

13. The portable information apparatus according to claim 11, wherein the second wireless communication antenna is positioned at a distal portion of the main body.

14. The portable information apparatus according to claim 11, wherein the second wireless communication antenna is a Bluetooth antenna.

15. The portable information apparatus according to claim 11, wherein the first wireless communication antenna is positioned at a side surface of the display unit and the second wireless communication antenna is positioned at a side surface of the main body.

16. The portable information apparatus according to claim 11, wherein the display unit is capable of opening and closing to the main body,
wherein the main body includes a first non-metallic member at a position on which the first wireless communication antenna abuts when the display unit is closed, and
wherein the display unit include a second non-metallic member at a position on which the second wireless communication antenna abuts when the display unit is closed.

17. The portable information apparatus according to claim 11, wherein the display unit includes a dielectric member at a position to which the first wireless communication antenna is attached,
wherein the first wireless communication antenna includes an antenna conductor section, feed line, and a GND pattern that are provided on the dielectric member of the display unit,
wherein the main body includes a dielectric member at a position to which the second wireless communication antenna is attached, and
wherein the second wireless communication antenna includes an antenna conductor section, feed line, and a GND pattern that are provided on the dielectric member of the main body.

18. The portable information apparatus according to claim 11, wherein the display unit includes:
a metallic member at position to which the first wireless communication antenna is attached; and
a dielectric member disposed on the metallic member of the display unit,
wherein the first wireless communication antenna includes an antenna conductor section, a feed line and a GND pattern that are provided on the dielectric member of the display unit,
wherein the main body includes:
a metallic member at position to which the second wireless communication antenna is attached; and
a dielectric member disposed on the metallic member of the main body, and
wherein the second wireless communication antenna includes an antenna conductor section, a feed line and a GND pattern that are provided on the dielectric member of the main body.
